(19) United States
(12) Patent Application Publication
(10) Pub. No.: US 2016/0338171 A1
(43) Pub. Date: Nov. 17, 2016

(54) A LIGHTING SYSTEM

(71) Applicant: GARDASOFT VISION LTD, Cambridge, Cambridgeshire (GB)

(72) Inventors: Peter BHAGAT, Cambridge (GB); William Frederick HILL, Cambridge (GB)

(73) Assignee: GARDASOFT VISION LTD, Cambridge, Cambridgeshire (GB)

(21) Appl. No.: 15/107,594

(22) PCT Filed: Dec. 23, 2014
(86) PCT No.: PCT/GB2014/053839

§ 371 Date: Jun. 23, 2016

(30) Foreign Application Priority Data
Dec. 24, 2013 (GB) 1323019.8

(51) Int. Cl. H05B 33/08; F21V 23/04

(52) U.S. Cl. CPC H05B 33/0893; F21V 23/0471; F21V 23/0457; H05B 33/0854; F21Y 2115/10

(57) ABSTRACT

A lighting system comprising, a light source, a controller arranged to drive the light source, a memory in communication with the controller, the memory being arranged to store at least one parameter giving at least one of a history of at least one variable characteristic of the light source; and/or at least one fixed characteristic of the light source, wherein the controller is arranged to drive the light source according to one of the stored history of the variable characteristic, the value of the fixed characteristic or both.

This invention relates to a lighting system and a method of driving a lighting system. In particular, but not exclusively, the lighting system is a system used in the field of automatic inspection, machine vision or the like. Typically, the lighting system is an LED lighting system.

A Machine Vision System (MVS) comprises components to capture images of items or scenes of interest and automatically analyse the image data in some way to extract data which can be used to generate measurements or decisions about the content of the image data. They are widely used and see application in a diverse range of applications from counting of particles in biological samples to calculating speed and capturing license plate information of speeding motorists.

It is helpful to describe the use of a lighting system in relation to a MVS using LEDs but this is for convenience and is not intended to be limiting.

Stable and consistent illumination is helpful in determining the quality of the acquired images and hence the performance of the MVS. As in general lighting applications, LED based lighting systems are increasingly used due to their long working life, typically never needing to be replaced for the life of the MVS and the ability to produce a wide variety of lighting geometries as dictated by the requirements of the image acquisition. Additionally, LEDs can be selected that produce light at specific wavelengths which can be used to advantage by the MVS designer.

Many MVS applications require the lighting to be “flashed” in synchronisation with one or more cameras in the system. This flashing may be regular or synchronised to detected events depending on the application. When flashing LEDs, it is possible to force the LEDs to run at significantly higher power outputs than their continuous ratings allowing much greater light output for the same light source size and cost. This is typically referred to as “overdrive”. However, in order for this to be useful for the MVS this has to be achieved with a high degree of control to ensure very stable flashes are achieved and protect the LEDs from damage by applying excessive overdrive.

All LEDs naturally “age” with use resulting in a reduction of the light output versus power input with time depending on a number of factors—time, average intensity level, duty cycle, overdrive conditions, thermal conditions, mechanical considerations. For an MVS, as stated previously, the illumination stability both long and short term affects performance. When flashing and overdriving LEDs, the repeatability of the flash timing is also important.

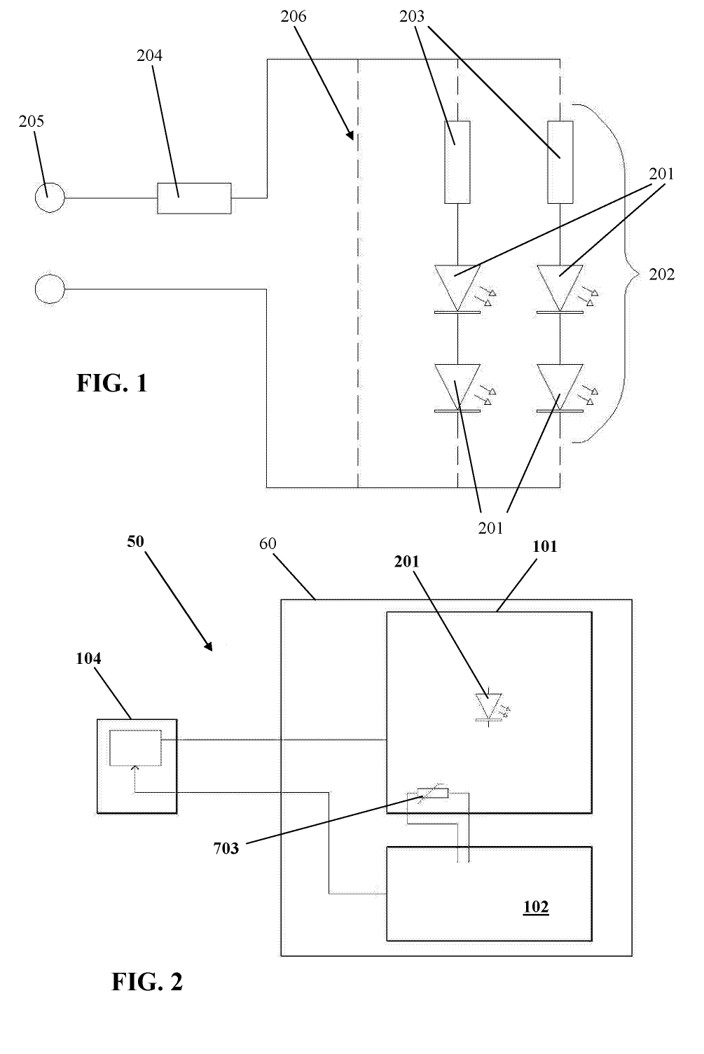

LED based MVS lights are usually designed using one or more LEDs 201 (FIG. 1) which are usually arranged in one or more “strings” 202 of LEDs connected in series often with several strings being driven in parallel by a single source. Each of these strings may have a resistor 203 in series. 206 indicates the potential presence of further such strings. All of the LEDs in a single serial “string” will have equal current passing through them at any one time however, the voltage required to be supplied by the drive circuit to achieve that current will be dependent on the sum of the individual Vf (Forward Voltage) values for each LED. Also, strings connected in parallel may not share the current equally between the strings if the total Vf in each string is not the same.

Some MVS LED lights are pre-configured to run at a nominal voltage by the inclusion of a simple series resistor 204 in the supply wiring and/or a resistor 203 in each LED string. This arrangement will not regulate the current if changes as described previously occur and this in turn will result in undesirable intensity variability and will also generate further heat in the series resistor. Additionally, overdriving (ie exceeding the designed steady state operating conditions) MVS lights configured in this way typically requires the voltage to be increased in proportion to the required percentage overdrive because of the series resistor leading to potentially high drive voltages. MVS lights designed to be driven by controlling the current do not need the series resistor and therefore generate less heat and also require lower voltages for overdriving.

Some MVS LED lighting manufacturers include some form of “personality” device within the light which allows an externally connected LED controller device to identify which model of light is fitted. A variety of methods are used, all via additional wires to the light. Examples of devices used are a simple resistor, the value being used to determine the model or an EEPROM memory device which contains data relating to the light.

According to a first aspect of the invention there is provided a lighting system comprising at least some of the following features:
a light source;
a controller arranged to drive the light source;
a memory in communication with the controller, the memory being arranged to store at least one parameter giving at least one of:
   a history of at least one variable characteristic of the light source; and
   at least one fixed characteristic of the light source.
      wherein the controller may be arranged to drive the light source according to one of the stored history of the variable characteristic, the value of the fixed characteristic or both

Embodiments providing such a system are advantageous in that they allow the controller to drive the light source more effectively, thereby potentially giving a more predictable light output, longer life of the light source, less energy consumption or the like.

According to a second aspect of the invention there is provided a method of controlling a light source comprising storing at least one of a fixed characteristic of the light source and/or a history of at least one variable characteristic of the light source as a parameter and accessing that parameter when determining the voltage and/or current used to drive the light source.

According to a third aspect of the invention there is provided a lighting system, which is typically a machine vision system, comprising at least one of the following:
a light source comprising a proximity sensor arranged to determine the proximity of an object to the light source;
a controller arranged to drive the light source; and wherein
   the controller is arranged to control the amount of light output from the light source according to the output of proximity sensor.

An advantage of embodiments of such as an aspect is that can help to improve the safety of the light source in that power output may be reduced if users come too close to the light source. Additionally, or alternatively, efficiency of the system may be improved if the light source is arranged to output power when object is close, perhaps within a predetermined distance.

According to a fourth aspect of the invention there is provided a lighting system, which is typically a machine vision system, comprising at least one of the following:
a light source having a having a predetermined nominal maximum drive current and/or maximum drive voltage; and
a lighting controller arranged to drive the light source by specifying a drive current and/or a drive voltage thereto; wherein
   the lighting controller may be arranged to measure the temperature of the light source and determine the current and/or voltage used to drive the light source as a function of the measured temperature wherein the controller is arranged to drive the light source above the maximum nominal drive current and/or voltage should the determination allow.

An advantage of embodiments providing such an aspect is that they can obtain more light output from a given light source than might otherwise be expected. Accordingly, such embodiments are more efficient and/or performs better due to the increased light available.

According to a fifth aspect of the invention there is provided a lighting system, which is typically a machine vision system, comprising at least one of the following:
a light source containing at least a memory and/or a controller and the light source having a power connection thereto; and
a lighting controller arranged to control the light source; and
   wherein the light source and the lighting controller may be connected by the power connections wherein the lighting system additionally comprises at least one of a signal carrying conductor in addition to the power connections and/or a signal imposed upon the power connections such that the signal carrying conductor and/or the signal imposed upon the power connection are arranged to carry data to the memory or controller.

An advantage of embodiments providing such an aspect of the invention is that they allow a memory and/or controller to be powered within the light source.

The skilled person will appreciate embodiments that impose a signal upon the power connections of the light source do not need an extra signal carrying conductor since the power connections then become capable of carrying data to the memory and/or controller.

The skilled person will appreciate that a feature described in relation to any one of the above aspects of the invention may be applied, mutatis mutandis, to any of the other features of the invention.

There now follows by way of example only a detailed description of embodiments of the present invention with reference to the accompanying drawings in which:

FIG. 1 (Prior Art) schematically shows a light source used by at least some embodiments;

FIG. 2 schematically shows a block diagram of a lighting system according to one embodiment;

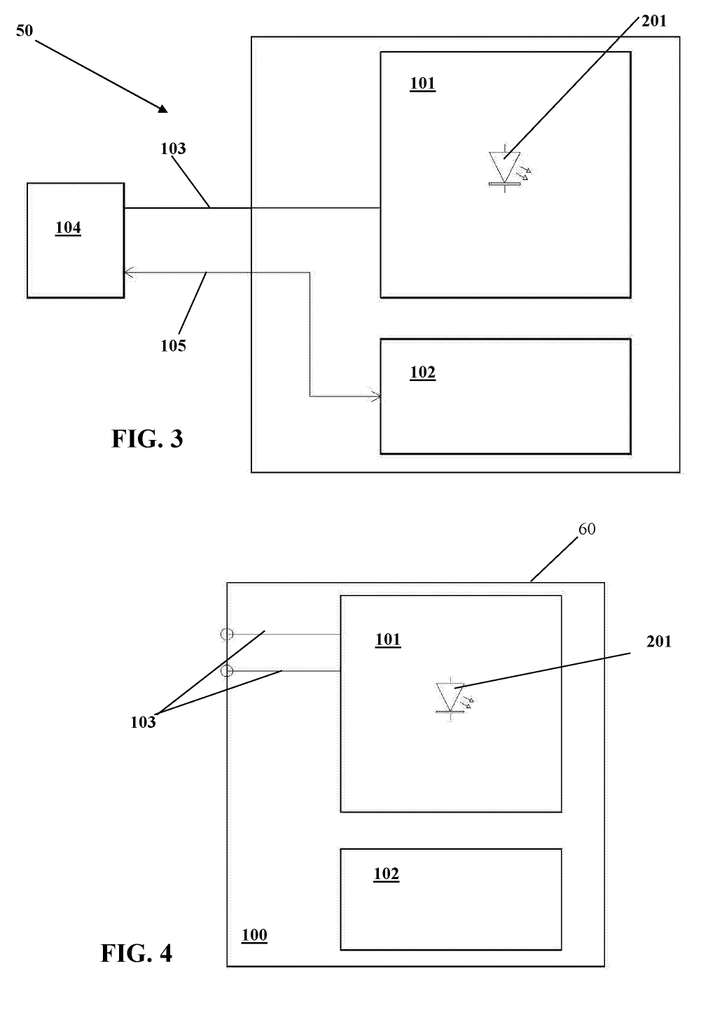

FIG. 3 schematically shows a block diagram of a lighting system according to another embodiment;

FIG. 4 shows an embodiment in which a memory is provided within a light source;

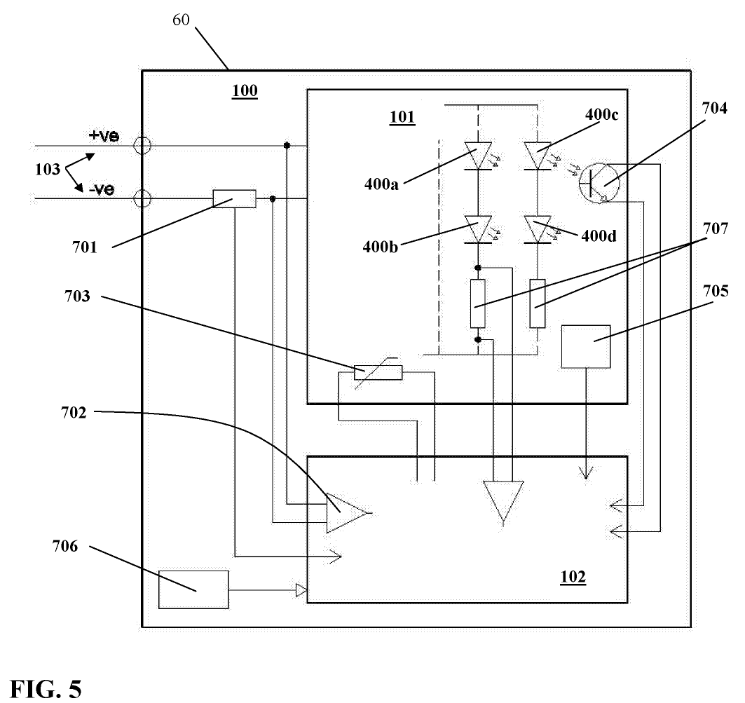

FIG. 5 shows sensors arranged to monitor a light source;

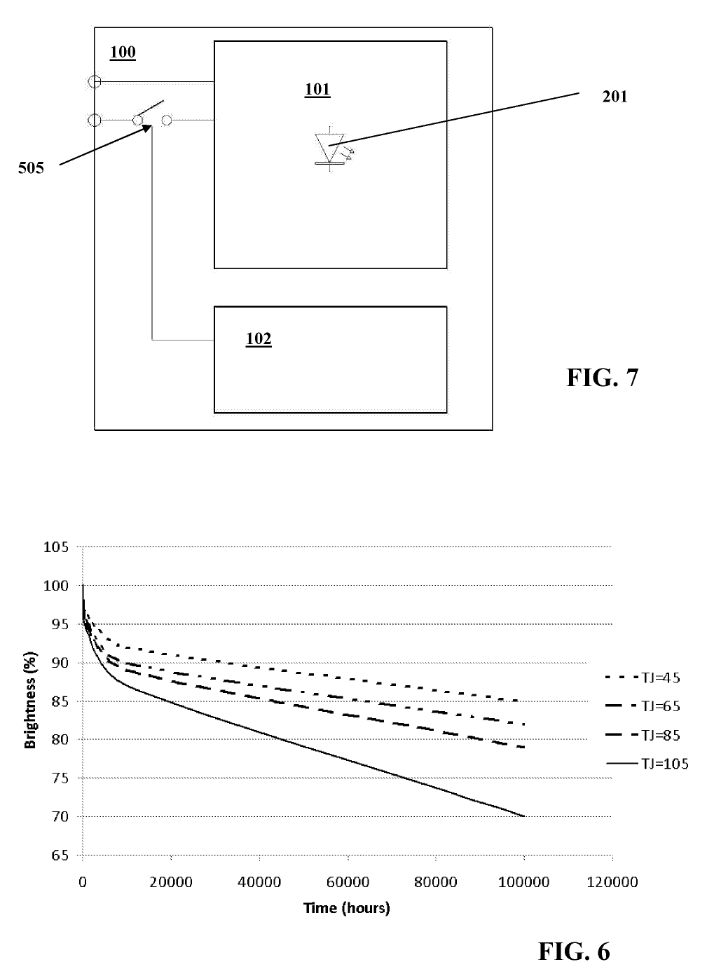

FIG. 6 shows a graph giving temperature characteristics of a light source;

FIG. 7 shows an embodiment having a switch within the light unit;

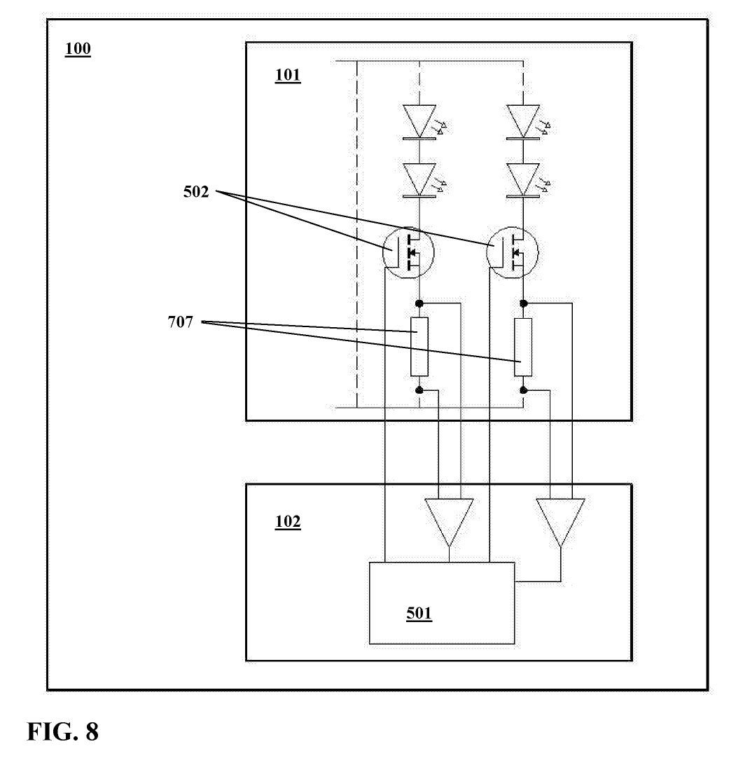

FIG. 8 shows an embodiment having switching elements disposed in a light source;

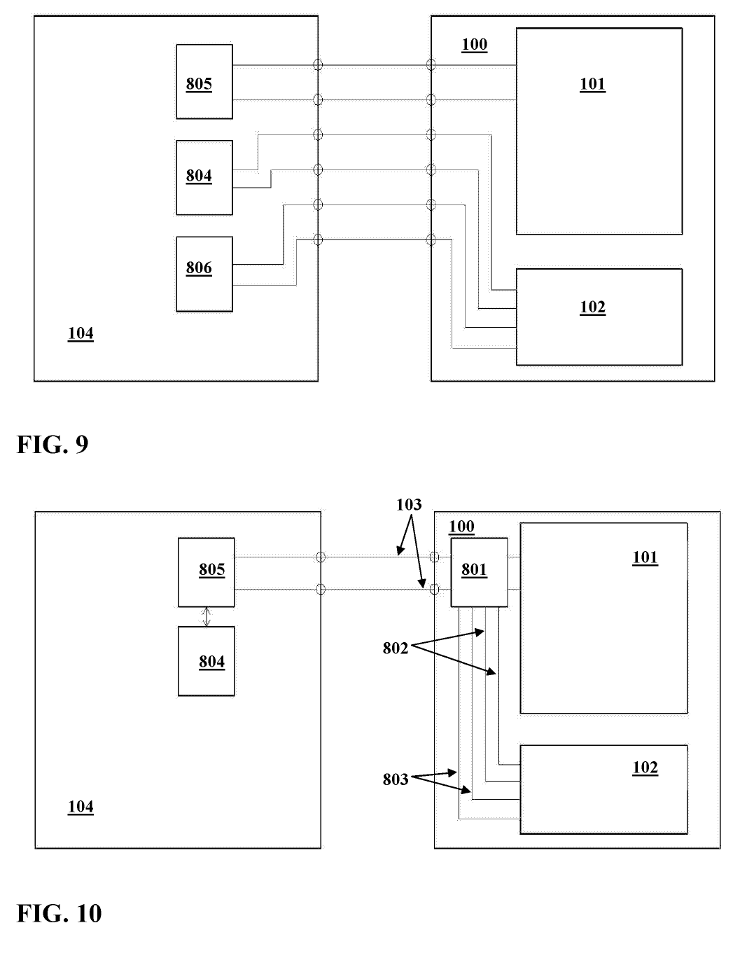

FIG. 9 shows an embodiment having a communication channel disposed between a lighting unit and a lighting controller; and

FIG. 10 shows a further embodiment of a lighting controller.

As described above, FIG. 1 is used to discuss the Prior Art use of strings of LED's. FIG. 2 is used to describe an embodiment which utilises a light source 101. In the embodiment being described the light source 101 comprises a plurality of LED's 201 but in other embodiments, this need not be the case and other forms of light source 101 may be provided.

In association with the light source 101 there is provided a memory 102 and both the memory 102 and the light source 101 are provided within a single housing 60. As such, the memory 102 remains associated with the light source 101 and should the light source 101 be moved between application, power sources, or the like, then the memory 102 also moves with the light source 101.

In the embodiment being described, the memory 102 is arranged to maintain parameters relating to the light source 102 which can be read, as described hereinafter, to identify the light source 102. The parameters held within the memory 102 includes the maximum drive conditions for that light source at a given temperature and this information is provided as a look up table with the memory 102. These conditions are for the steady state in which the light source 101 is driven by a substantially steady current and provide what may be thought of as being a predetermined nominal maximum drive current and/or maximum drive voltage. Other embodiments may provide different information as described hereinafter.

In addition to the memory 102 the housing contains a temperature sensor 703 associated with a housing of the LED 201. Processing circuitry associated with both the memory and temperature sensor 703 allows the temperature of the housing of the LED 201 to be read from time to time and output as described hereinafter.

Other embodiments may be arranged to record an historic record of the temperature of the light source 101 thereby maintaining a record of temperature of the light source 101.

Also shown in the Figure, is a controller 104 which is arranged to read the memory 102 and is also arranged to read the instantaneous value from the temperature sensor 703. In this embodiment, the controller 104 is arranged, from time to time, to poll the temperature sensor 703 to obtain the temperature. In this embodiment, the controller 104 is arranged to poll the temperature sensor at substantially a regular interval of roughly every 5 seconds to ensure that it is not operating outside of its desired operating temperature. However, in other embodiments other time periods may be appropriate.

In use, the controller 104 is arranged to access the memory 102 to identify the light source 101 and the associated maximum drive conditions for the light source 102 and also to read the current temperature of the housing of the light source 101 via the temperature sensor 703. The controller 104 is then arranged to process the data so obtained and determine, for that light source 101 a set of determined drive conditions that are then used to drive the light source 101.

In this embodiment, the drive conditions are those needed to specify a Square Wave that is used to drive the light source: the ON time of the light source 101; the off time of the light source 101 and the current and voltage used to drive the light source 101 during the ON period (ie the amplitudes of the square wave).

In determining the drive current the controller 104 is arranged to take into consideration the temperature of the light source 101. Here, it is noted that the parameters read from the memory 102 give a maximum drive current for a given temperature in the steady state. As such, it is possible to overdrive (ie to provide more that the given drive current) if the light source is operating at a lower than expected temperature and/or in non-continuous manner. Such an embodiment is advantageous as it allow more light to be obtained from a given light source.

In the embodiment being described, the controller 104 is arranged to determine the current to be used and to subsequently to use that current for that light source 102. That is, the calculation is performed when the system is initialised, and perhaps periodically after that.

A further embodiment of the a lighting system 50 according to another embodiment is shown in FIG. 3. Again, the lighting system 50 comprises: the light source 101; the controller 104 arranged to drive the light source; and the memory 102 in communication with the controller 104. As described below the memory 102 and controller 104 may each be provided as part of a light source 101 (eg within the housing 60) or by connection to a light source 102.

The memory 102 is arranged to store one or both of: a history of at least one variable characteristic of the light source 101; and at least one fixed characteristic of the light source 101. The controller 104 is arranged to drive the light source 101 according to the stored history of the variable characteristic or the value of the fixed characteristic or both.

The lighting system 50 further comprises a power cable 103 which connects the light source 101 to the controller 104. A communication link 105, arranged to carry data, can be provided between the memory 102 and the controller 104. In some embodiments this communication link 105 is a separate cable but in alternative, or additional, embodiments the communication link 105 could be provided by other conductors within cable 103. Further, the communication link 105 may be provided by a signal, carrying data, that is superimposed onto the power conductors within the cable 103 driving the light as described later or as a wireless link.

In the embodiment shown in FIG. 4, the memory 102 and the light source 101 form a single light unit 100 and are enclosed in a single case or housing 60. Such an embodiment is also shown in FIG. 5, in which the memory 102 and light source are shown contained in unit 100 and the controller 104 is separate from the light unit 100.

In other embodiments, the controller 104 may be incorporated into the light unit 100. In yet other embodiments, light unit 100 may contain only the light source 101, with the controller 104 and memory 102 separate.

The light source 101 comprises one or more LEDs 400a-d, and in some embodiments may contain additional components such as at least one resistor 707 or other components to control the voltage and/or the current passing through the LED(s) 400a-d.

The light source 101 may further comprise at least one sensor 705 arranged to measure characteristics of the light source. Depending on the type of sensor, they might be in close proximity to the light source 101, or within the light source 101 as it is shown in FIG. 5.

In some embodiments, one or more sensors may additionally, or alternatively, be located remote from to the light source. For example, a sensor to measure the light output might be located at a distance from the light source 101 such as the LED(s).

Temperature sensors may be mounted close to the light source 101 such as the LED(s) on mounted on a heatsink attached to the light source. It will be appreciated that such embodiments are useful, particularly where the light source 101 is an LED as LEDs can generate significant amounts of heat which unless managed can cause damage to the LED, shorten its useful lifespan, etc. Therefore embodiments having such a temperature sensor can ensure that the temperature of the light source 101 is taken into account when the drive conditions (typically the current and/or voltage) are being determined for the light source 101.

### Memory

The memory 102 may comprise a non-volatile memory, for example an EEPROM or a processor's flash memory. The memory 102 is arranged to store, as parameters therein, one or both of: a history of at least one variable characteristic of the light source 101; and at least one fixed characteristic of the light source 101. In other embodiments there may be provided more than one memory, which may be arranged to store different data, or indeed may be arranged to store duplicate data. In additional, or alternative, embodiments the controller 104 may comprise a memory portion arranged to store parameters.

The parameters stored by the memory may be any one or more of the following:

LED Lifetime Data
Lifetime and ageing data, which may be as provided from the manufacturer fo the LED(s).

Parameters Helpful in Calculating the LED Junction Temperature
Arrangement of LEDs and resistors inside the light source
Thermal resistance from LED junction to the LED case
Thermal resistance to temperature sensors and heatsinking routes in the light source

Parameters Helpful in Ageing and Lifetime Calculation
Cumulative estimated age of the whole light or parts of the light
On-time (ie the amount of time the light source has emitted light)
Measured light value at current time

Proximity Sensor
The proximity sensor input level at which event should happen
Action to take on event
Maximum intensity for safe operation in the presence of a person

QA Information (Quality Assurance)
Average temperature rise above ambient at a range of currents, duty cycles
Light sensor or usage and light degradation information of the light
Effectiveness and balance of heatsinking
Comparison of calculated ageing with actual ageing
Saved average usage of the light, including the on-time, actual temperature, temperature rise and the average current used to drive the light
Most common usage conditions
Conditions where the maximum operating parameters were exceeded

Light Characteristics and Limits
Maximum LED junction operating temperature
Maximum continuous current
Max pulse width and duty cycle at a range of overdriving percentages and temperatures
Current/voltage curve

Constant Light Levels/Improved MVSs (Machine Vision System)
Reactive characteristics of a light
Current/intensity curve
Current adjustments needed to set substantially the same brightness as a reference light
Voltage corrections to be applied to each string to balance the brightness of each
Target brightness as measured by the light intensity sensor
Adjustments needed as the effective age of the light increases
Adjustments needed as the temperature of an LED changes
Adjustments need to balance different strings of LEDs
How segments are sequenced

Communications
Addressing information
Data speed, format

User Information
Serial and model number
Basic characteristics of the light, such as active length, dimensions
web link to the user documentation

### Measurements

The lighting system 50 can make various measurements of the conditions of the light source 101 and the signals applied to it. In the embodiment being described, these include the voltage and current applied to the light source 101, the temperature of the light source 101 and surroundings and the actual brightness of the light source 101. Embodiments may also record the time duration and duty cycle of these values in order that these parameters may be used in later calculations. Other embodiments may measure additional, or other, parameters.

Embodiments may drive the light source, and in particular LED light sources, in a flash mode where the light is turned on for short periods, generally in synchronisation with another component in the system, which is typically the camera. The flash mode is typically driven by a square wave. Whilst the reduced on-time achieved when flashing the light source will proportionately reduce the average heat generated this is not generally linearly equate to an ability to over-drive the light source by an equivalent amount during the ‘on’ time. As such, local heating effects within the light source, caused by high overdrive current, can cause accelerated ageing, damage or even device failure. As such, embodiments that record the degree of overdrive are advantageous to mitigate these negative effects.

Overdrive is usually expressed in relation to the maximum continuous drive current of the light source (ie the 100% value). Therefore flashes at 200% overdrive indicates that the current through the LEDs is twice that specified as the maximum continuous current specified for the Light Source (eg LED) during the flashes. Depending on the actual duration and frequency of the flashes and the characteristics of the light source used, overdrive values in excess of 500% are sometimes possible.

It is noted that the intensity of an LED is generally proportional to the drive current up to is maximum continuous drive current.

In order to measure the conditions of the light source 101, the lighting system 50 may comprise one or more sensors, as shown in FIG. 5. The current flowing to the light can be measured using current sensor 701. Alternatively, or additionally, the current for each LED string making up the light source 101 can be measured using a current sensor in each string 707. In some embodiments, these sensors are a small value series resistor and differential amplifier but in other embodiments could be another type of sensor able to measure a current.

In the embodiment of FIG. 5, the voltage applied to the light source 101 is measured with a differential amplifier 702.

In the embodiment of FIG. 5, the temperature of the light unit 100 can be measured with a thermistor 703 or other temperature sensor. In the embodiment shown in FIG. 5 there is one temperature sensor 703. In other embodiments there may be a first temperature sensor arranged to measure the temperature at a first position on the light source 101 or the ambient temperature, and a second temperature sensor arranged to measure the temperature at a second, different, position on the light source 101. In other embodiments there may be further temperature sensors arranged to measure the temperature at any number of positions.

In the embodiment of FIG. 5, the actual light output, peak wavelength, colour temperature and other properties of the light can be measured with optical sensors 704.

In other embodiments, any other measurements of the light source, conditions or environment could also be made.

### Aging and Lifetime Characteristics

In some embodiments, the controller 104 is arranged to calculate an aging parameter of the light source 101. The aging parameter may be calculated from the stored history of the light source temperature at one, or multiple positions on the light source 101, such as measured by the temperature sensor 703. The controller 104 may also be arranged to calculate an aging parameter from the light source drive current, as measured, for example, by the current sensors 701, 707. The aging parameter can be stored in the memory 102 or within the controller 104.

In some embodiments, the aging parameter may be found using one or more of: a cumulative estimated age of the whole light source 101 or parts of the light source 101, the light source on-time (ie the amount of time for which the light source 101 has been illuminated) and the measured light value at a present time.

The ageing parameter can be the percentage brightness compared to a new light source. This method assumes that at a given amount of ageing, the future ageing will only be dependent on the future conditions and that it will not matter if the light reached this ageing point by being operated at (for example) 70 deg C. for 20000 hours or 90 deg C. for 10000 hours. For example, given the graph in FIG. 6, at a constant 65 deg C. junction temperature (TJ), the light source will be at:
97.5% brightness after 100 hours
90% brightness after 10000 hours
82% brightness after 100000 hours

Therefore the ageing rate for each of these brightness ranges can be calculated. The ageing rate will be approximately:
0.025% per operating hour from 0 to 100 hours
0.000377% per operating hour from 100 to 10000 hours
0.000089% per operating hour from 10000 hours to 100000 hours

From this data, the reduction in brightness can be calculated for each period of use. The updated ageing data may be written to memory 102 on a regular basis, for example every hour, or when the power is detected to be about to fail. As described elsewhere some embodiments may be arranged to power the memory 102 and/or controller 104 using a square wave or similar waveform and embodiments that write to memory during a powered portion of the square wave are advantageous for embodiments power in via non-constant waveforms (such as a square wave) at least.

These graphs generally give the ageing when the light source is driven at 100% brightness or overdriven at its maximum duty cycle (see Osram LH CP7P LED Data sheet, page 10, which is hereby incorporated herein by reference).

When there is no current passing through LEDs, it may be assumed not to age. Therefore if a LED is driven at 100% brightness but for only 50% of the time, it only ages at half the rate. Also when overdriving at less than the maximum allowed duty cycle, the lifetime is extended accordingly.

Some embodiments may arrange the controller 104 such that it uses floating point numbers for the calculations it performs in order to provide the desired accuracy. Accordingly, in such embodiments, the lighting system 50 is arranged to hold any parameters that it stores in floating point format. Other embodiments in which the precision is not so critical the memory 102 and/or the controller 104 may be arranged to hold/process respectively integer number, or the like,

Lifetime and aging dated can be stored as fixed parameters in the lighting system 50. Typically the information that is available on the aging characteristics of a light source (eg LED) is provided as a graph showing how the brightness reduces over time, assuming a certain current. Sometimes these graphs give curves for different LED junction temperatures (TJ) and an example of such a graph is shown in FIG. 6. The graph shown in FIG. 6, as is typical for such graphs, ends at 100,000 hours, even if the brightness is still over 70%.

The graph of FIG. 6 is fairly linear. To store graphs that are substantially linear, it may be sufficient to store a small number of points for each temperature and interpolate intermediate points and the embodiment being described stores the substantially linear graphs in this manner.

The end-point of a light source such as a LED's lifetime can be taken as the point where the brightness reaches 70% of its initial value. This is an arbitrary definition, but it relates fairly well to practical applications, and in particular use in machine vision systems.

### Calculating Light Source Junction Temperature

The controller 104 may be arranged to calculate the power dissipation of individual components making up the light source 101 in accordance with the light source circuit layout information stored in the lighting system 50. As described above, the lighting system 50 may store any one or more of the arrangement of LEDs and resistors inside the light source, thermal resistance from LED junction to the LED case and thermal resistance to temperature sensors and heatsinking routes in the light.

The maximum LED junction operating temperature can be set by the light source manufacturer to a value where the reliability and lifetime of the light source will be within acceptable limits. It can be set by the judgement of the manufacturer by consulting the lifetime graphs of the data sheet for the light source, eg. LED, used.

As shown in FIG. 1, the light source 101 may comprise an arrangement of one or many LEDs and one or many resistors. The arrangement of LEDs and resistors can be stored, as a parameter, within the lighting system 50. A typical set of parameters might be:
Number of LEDs in each string (could just be 1)
Resistance value in each string (0 if there is no resistor)
Number of strings in parallel (1 if there is only one string)
Resistance in series with the external connection (0 if there is no resistor)

These parameters can be used to relate the electrical power driving the whole light source 101 to the power in each LED which make up the light source 101.

With these parameters, the embodiment being described is arranged to work out the temperature difference from the temperature measurement to the junction temperature for a given amount of power that the LED is being driven with. The LED junction temperature is calculated using the following equations:

<LED junction temperature(deg C.)>=<temperature measurement(deg C.)>+<thermal resistance(deg C./W)>*<average LED power>

The average LED power for continuous mode is given by:

<average LED power(W)>=<LED current(A)>*<LED voltage(V)>

For pulse mode it is given by:

<average LED power(W)>=<LED pulse current(A)>*<LED voltage(V)>*<pulse width(seconds)>*<pulse frequency(Hz)>

Or:

<average LED power(W)>=<LED pulse current(A)>*<LED voltage(V)>*<pulse duty cycle (%)>/100

The LED voltage can be determined from the parameters held which give the LED characteristics, which gives an estimation of the LED voltage needed for any current. Typically such parameters provide sufficient data to allow a close enough approximation for lifetime calculations.

The effective thermal resistance of the LED from the junction to its case is given in the data sheet for the LED provided by the manufacturer; ie it is a known parameter. It can also be stored in the lighting system 50 as a parameter in the memory and the embodiment being described is arranged to do this. Measuring the temperature of the material near the LEDs gives an approximation to the temperature of the case of the LED and this in conjunction with the thermal resistance can be used to allow for a more accurate calculation of the junction temperature TJ.

In embodiments where there are multiple temperature sensors, including an ambient temperature sensor, a more complex calculation of the LED junction temperature can be calculated from the temperature measurements, and the pre-set thermal resistances of the paths from the junctions to the sensors and ambient.

### Quality Assurance Information (QA)

The lighting system 50 may also be arranged to store parameters, within the memory 102, that relate to quality assurance information. These parameters may include any one or more of the following:
Average temperature rise above ambient at a range of currents, duty cycles
Light sensor or usage and light degradation information of the light
Effectiveness and balance of heatsinking
Comparison of calculated ageing with actual ageing
Saved average usage of the light, including the on-time, actual temperature, temperature rise and the average current used to drive the light
Most common usage conditions
Conditions where the maximum operating parameters were exceeded

An advantage of embodiments is that manufacturer's QA information can be stored in the lighting system 50. If the lighting system 50 (or at least components thereof) is returned to the manufacturer, some performance data can be extracted from the lighting system which may be useful for instance for diagnostic information or the like.

For example, if the current through each string is measured, the level of imbalance between strings can be recorded as a parameter with in the memory 102 and/or controller 104. For product improvement the maximum difference between strings would be useful to the manufacturer.

For the embodiment in which the lighting system comprises a light sensor 704, the predicted ageing, actual ageing and the variation between the two are all useful for refining the ageing algorithm described above.

Information on the temperature rise above ambient can also be saved as a parameter, so that the effectiveness of a heatsinking used in association with the light source 101 can be determined.

In the embodiment where the lighting system 50 comprises multiple temperature sensors, the lighting system 50 may be arranged to store, as parameters, the average temperature of each sensor during operation. This will show where parts of the light source 101 are hotter than others. This information can be used to improve heatsinking which will give better performance and reduce the uneven ageing of the light source.

Some embodiments of the lighting system 50 allow a user to define which parameters the lighting system 50 is arranged to record. Such embodiments are useful as different parameters are likely to be useful for different purposes. For example, it might be useful to save, as a parameter, some usage information on the most common sets of conditions.

In view of the fact that it can be difficult for a user to decide which sets of conditions should be stored as a parameter, embodiments may be arranged such the lighting system partitions the conditions that it is recording as a parameter into small ranges, and then keeps parameters on the most common ranges plus one or more of the most recent.

A record of the parameters with the lighting system 50 would then hold at least some of the following: the combination of conditions, the sum of measured values, the number of measurements, the length of time this combination was active and a sequence number saying how recent this combination was used. Here the sequence number may, in one embodiment, be arranged such that a 1 represents the most recent combination, 2 for the next most recent, etc.

Embodiments which are able to tailor the stored parameter in this manner should allow a user to experiment with a number of different setups before deciding on the best one for his/her purposes and using that long term. Embodiments which use the sequence number are believed advantageous to prevent parameters relating to recent e experiments over writing long term parameters.

For example, if the temperature rise is to be stored for different conditions of intensity, pulse width, duty cycle, the pulse current could be split into ten equal ranges from 0% to 1000%, the pulse width into ten ranges of 100 μs from 0 μs to 1000 μs, plus another range for greater than 1000 μs, and the duty cycle could be split into 10 equal ranges from 0% to 100%. This gives 1100 possible combinations of these ranges of which typically only a small number will be used. In this example the manufacturer might decide to allocate memory records to hold parameters giving the 5 most common combinations and the most recent 3. When the user starts using the light system, the controller 104 is arranged to calculate which range each measurement belongs in. As different settings, which give different range combinations, are used the 8 records are filled up. When a ninth combination is found, the controller is arranged to look for the record which has been used for the least amount of time, but is not in the most recent three and then over write that record.

By doing this the most common combinations are hopefully held, but more recent combinations can supersede them if they become more common.

Some embodiments may be arranged to store, within the lighting system 50, records as to when the light source 101 was used outside its operating parameters. This is useful to the manufacturer for diagnostic and warranty reasons.

### Light Characteristics and Limits

The light characteristics will typically be determined by the manufacturer of the light source when it is designed. Thus, the manufacturer is able to provide data on the light source to ensure it can be used without damage and with an acceptable ageing rate. Such characteristics can be stored in the lighting system 50 as fixed parameters within the memory 102. Embodiments in which the memory 102 is situated within the light source 101 be particularly suited for storing fixed characteristics in this manner.

In some embodiments, the one or more of the following parameters can be stored about the characteristics of a light:
Maximum LED junction operating temperature
Maximum continuous current
Max pulse width and duty cycle at a range of overdriving percentages and temperatures
Current/voltage curve

The maximum continuous current is generally a standard value taken from the data sheet of the light source, eg LED, used. At this current the light source 101 is running at 100% brightness. Note that depending on the effectiveness of the heatsinking the manufacturer might use a different value.

In some embodiments, the controller is arranged to calculate the rise and fall edges of light source pulses according to the light source capacitance and/or inductance characteristic. These can be useful in optimising the speed of rising and/or falling edges of pulses of the light source 101 (eg LED).

These limits can be described by a table such as that given in RT200 User Manual version 10b, overdriving limit table in section 6.1.2, Gardasoft (reference 1). The pulse width limits can be stored in the lighting system 50 as points on a graph, and intermediate points interpolated. For example the pulse width limit table in reference 1 could be coded up as the following data pairs, giving the percentage intensity and pulse width limit for that intensity:
(100%, 999 ms)
(200%, 30 ms)
(300%, 10 ms)
(400%, 2 ms)
(500%, 1 ms)
(1000%, 1 ms)

Alternatively, this curve might be stored with more points in order to give greater accuracy, such as in the following:
(100%, 999 ms)
(101%, 30 ms)
(200%, 30 ms)
(201%, 10 ms)
(300%, 10 ms)
(301%, 2 ms)
(500%, 2 ms)
(501%, 1 ms)
(1000%, 1 ms)

The pulse width limit can be coded up as a similar set of points on a graph curve. The last point on the curve effectively specifies the maximum overdrive percentage allowed, although some embodiments may store this as an explicit value.

Graphs of the forward voltage required across a light source 101 such as an LED, for the range of currents from 0% to the maximum overdrive current can be stored as parameters in the lighting system 50 for a range of temperatures. These parameters can be used for calculating LED junction temperatures and for calculating the power needed from a switch mode power supply to drive the light.

In one embodiment, the voltage and/or current are measured by the controller 104, and in response to those measurements the controller 104 is arranged turn the light source 101 off. In some embodiments, the light source 101 can be turned off if it is detected that any one of the current, voltage, lighting temperature, LED junction temperature or average power to the light source 101 is too high and might cause damage to the light source 101. If this protection is built into the light source 101, this can work even if a third party driver or standard DC supply is connected to the light. If the light source is deactivated in this way by the controller, the deactivation even can be stored in the lighting system 50 as a parameter.

FIG. 7 shows an embodiment in which the lighting system 50 comprises a switch 505 inside the light unit 100. The switch 505 is arranged to disconnect the light source 101 from the input power to protect the light source. In other embodiments, the light system may comprise a control switch 502 in each string, as shown FIG. 8, to provide further protection. This switch 502 may be a transistor.

### Proximity Sensor

In some embodiments, the light system 50 further comprises a proximity sensor. In such embodiments, the lighting system 50 is arranged to store parameters for at least one or more of the following p:
The proximity sensor input level at which event should happen
Action to take on event
Maximum intensity for safe operation in the presence of a person

For some applications of the lighting system, it is useful to trigger an inspection when an object comes close to the light source 101. In some embodiments, the lighting system 50 can be arranged to cause an external trigger to be sent to a camera to take an image and can trigger the light source 101 to pulse at the same time. This reduces cost due to higher levels of integration and produces a very simple and easy to set up system.

Eye safety is an important issue with LED lighting. Near infra-red lights are invisible or nearly invisible to humans and do not cause the person to blink or look away from the light. The blue wavelengths in white light can cause eye damage even though it is visible. Eye safety is much easier to achieve if it is known that a person will not be within a certain distance of the light.

In some embodiments, the lighting system 50 comprises a proximity sensor is fitted to the light source 101 and the controller 104 is configured either to raise an warning signal or to turn down the light source to a safe level or turn off the light source when a person or object is detected within a predetermined range to the proximity sensor, thus providing a safer environment and possibly reducing the risk class for the light source. The predetermined range may for example be roughly 100 mm, 200 mm, 300 mm, any number in between, or the like.

### Additional Overdriving

Some lighting systems have limits on overdriving. These limits typically specify the maximum combination of overdriving percentage, pulse width and duty cycle. These limits are set so that they are safe at the maximum ambient temperature.

In some embodiments, the lighting system 50 is arranged to store a parameter giving any one or more of the following the ambient temperature, LED junction temperature or light PCB temperature. Based on this information the overdriving of the light source 101 can be optimised. If the ambient temperature is lower than the maximum in the specification or the heatsinking is better than minimum, then it is likely that the light can be overdriven more. This will give an advantage, in particular for machine vision systems applications.

Also, with information on the temperature and effect on ageing, an informed compromise can be made about overdriving harder, with knowledge of the impact on lifetime.

### Constant Light Levels/Improved MV (Machine Vision) Systems

In some embodiments, the lighting system 50 is arranged to store parameters in relation to any of the following:
Reactive characteristics of a light
Current/intensity curve
Current adjustments needed to set the same brightness as a reference light
Voltage corrections to be applied to each string to balance the brightness of each
Target brightness as measured by the light intensity sensor
Adjustments needed as the effective age of the light increases
Adjustments needed as the temperature of an LED changes
Adjustments need to balance different strings of LEDs
   How segments are sequenced

This can be used to give more repeatable light levels, which is particularly useful to produce more reliable machine vision systems.

In some embodiments, the reactive characteristics in the light source 101 can be stored, as a parameter in lighting system 50, as an equivalent network of inductor and capacitor values. This can be used to match the impedance of the lighting controller 104 power output to the effective impedance of the light source or to give an extra boost to the start of the pulse. This allows faster rise and fall edges to a lighting pulse and more stable driving of the light source 101.

If the light source 101 is replaced, it is useful to be able to replace it with a light source of the same intensity, without variation due to tolerances of components or higher efficiency of newer component of the light source (eg LEDs). The manufacturer can have a reference light which all production lights are compared to. Production lights can then have adjustments stored in the memory 102 which means that for gives percentage brightness, it gives very close to the same brightness as the reference light. These adjustments would be generated by measurement during the manufacturer's production test.

The simplest way to account for these differences is to adjust the current/intensity curve, so that for a required intensity, the current to achieve the same light source 101 level as the reference light is given.

When overdriving the light source 101, the intensity will typically not increase as fast as the overdrive factor. So for example when an LED is driven at 200% of its maximum continuous current, the actual intensity might only increase by 170%. In some embodiments, the lighting system 50 is arranged to store a graph, perhaps in the form of a look-up table, a function, or the like, of how the intensity increases from 0% to the maximum overdrive percentage. This can then be used to set a nearly exact brightness for the light source 101. For example, using this graph, the controller 104 could determine that the pulse current needs to be 360% of the current rating to achieve 300% brightness; ie the controller could determine the overdrive current needed to generate the desired light output.

This graph could have a number curves for different junction temperatures. The efficiency of an LED decreases as temperature increases. So for higher temperatures more current is needed to achieve the same brightness and these additional curves would allow compensation for temperature changes during the initial heat up phase of the light and during further operation.

In the embodiment where the lighting system 50 is arranged to have a light sensor measuring the brightness of one or more LEDs, the brightness measurement can be used as a feedback to maintain constant brightness over time. It can also be used to ensure that any brightness setting is a true percentage of the 100% brightness level, giving linear brightness settings.

In the embodiment where the ageing of the light source 101 has been calculated, this can be used to manually or automatically compensate for the reduction in brightness due to ageing over a period, which may for example be many years. The initial pulse or continuous current to the light could be set to lower than the maximum achievable at the beginning of the life. As the light ages over time, the current is increased to compensate.

In the embodiment where the ageing is known from a light sensor or is calculated, the replacement time of the light source can be predicted. Typically this would be determined as the point where the light source 101 could not maintain constant brightness any more.

In an embodiment where there are parallel strings 202 of LEDs in the light source 101, the LED strings will share the current supplied to the light source. In some embodiments, a resistor is included in each string to help the strings share equally. However the strings will still usually have different currents due to the tolerance on forward voltage of the LEDs. In practice, even with LEDs selected to have close values there can be a 10% variation. In a practical systems a 1V variation in a string of LEDs with a nominal total forward voltage of 46V has been observed. The skilled person will appreciate that the higher the value of the resistor in the string, the better the strings share, but the more heat is generated.

In an embodiment where a current through individual strings is measured, it is possible to record, as a parameter within the lighting system 50, how equally the LED strings share the current. This can be recorded for QA purposes. With a small regulation circuit it is also possible to adjust the current in each string 202. This circuit could be arranged to only drop a small voltage so as not to generate much heat and require little or no heatsinking. This is shown in FIG. 8. A subsystem 501 reads the strings currents through a measurement circuit 707 and provides control to a small regulation circuit 502, which could be a transistor.

In some embodiments, strings of LEDs are arranged so that each string is in a defined area of the light source 101. An advantage of such embodiments is that it allows some sections to be turned on and off so that the angle of the light reaching the subject can be controlled. In some embodiments, these are arranged so that a low angle (called dark field in machine vision) or high angle (bright field) light is turned on. Sometimes for inspecting electronics the light is arranged to turn on segments of a circle, for example four quadrants are turned on in sequence. A light source 101 having an internal controller 104 and/or memory 102 may be arranged to provide the switching of those strings from within, thereby saving on cabling and complexity of the overall system. The embodiment of FIG. 8 may be arranged to provide such functionality where the subsystem 501 turns strings on or off using the small circuit 502. In the embodiment shown in FIG. 8 the subsystem comprises both a controller 104 and a memory 102.

### Communication/Cabling

Memory 102 and controllers 104 require power and a communications channel. The provision of power and/or communications to the memory and/or controller may be provided by adding two or more extra conductors to the light cable as shown in FIG. 9. In the lighting controller 104 the lighting driver 805 supplies power to the LEDs in the light source 101, the communications source 804 has a communications link with the memory 102 and power for the memory is supplied by 806.

In one embodiment a single wire is provided to provide power and communication is provided on two further wires. With more conductors, the power could be on separate conductors and the protocol could be RS232 or RS485 or similar.

Other embodiments may be arranged to provide communications and/or power for the memory 102 and/or controller 104 on the existing wires powering the light unit 100. Such embodiments are advantageous for reasons of backwards compatibility and such an embodiment is shown in FIG. 10. The lighting cable 103 carries lighting power and the communications data. A module 801 takes the light cable input and extracts the communications data onto wires 802. It also extracts power and supplies this to the memory 102 on wires 803.

Within the controller 104 the lighting driver 805 takes a communications signal and superimposes it on the lighting drive output.

The method of encoding data can be one of a number of existing technologies. An example would be to insert very short voltage spikes onto lighting power. The time distance between spikes can be used to indicate a 0 or 1.

Embodiments are typically arranged not to disturb the operation of the LEDs or other light source. The spikes could be filtered out on the power send to the light source 101, or a balancing negative spike could also be inserted, so that the average power to the light source remains constant.

In some embodiments, the system is arranged to deliver roughly 3.3V at 1 mA which is enough to drive low voltage digital circuits.

It will be appreciated that when the light source 101 is being driven in pulse mode, there will only be drive to the light source 101 during pulses, and the pulse length will be governed by the Application and may well therefore be unknown.

In one embodiment, the memory 102 and/or controller 104 is arranged to perform the functions it needs to using the power it gets during a pulse and before it loses power.

In an alternative the system is arranged to apply a low voltage, for example 1V on the lighting cables 103 when the light source 101 is not illuminated, sufficient to power the memory 102 and/or controller 104. This is below the minimum forward voltage for even a single LED, so the LED will not illuminate, but 1V can be used by the memory 102 and/or controller 104 for power. Some embodiments may be arranged to step up the low voltage power supply should more voltage be needed. Such embodiments are also arranged to limit the voltage supplied to the memory 102 and/or controller 104 when a higher voltage is being supplied to the light source 101 during an ‘on’ cycle.

Module 801 may be arranged to maintain the operation of the light source 101 even when a standard lighting controller which doesn't have this technology is connected, for backwards compatibility. In this case extracting power from the lighting power will slightly reduce the power to the LEDs. In such an embodiment, the memory 102 should be arranged to use as little power as possible, for example by using low power devices, reducing clock and sampling speeds and using sleep modes on devices where possible.

Reference herein to the lighting system 50 being arranged to store a parameter will be recognised to mean that one or both of the memory 102 and the controller 104 are arranged to store the parameter noting that controllers 104 may themselves comprises a memory. It will also be appreciated that the memory 102 may be distributed or accessible over a connection, which may be wired or wireless, thereto.

It will be appreciated that several embodiments are described above in relation to the various aspects of the invention that have been described. The skilled person will fully appreciate that a feature described in relation to any of the embodiments of the invention may well be applicable, mutatis mutandis, to any of the aspects of the invention.

1. A lighting system comprising:
a light source;
a controller arranged to drive the light source;
a memory in communication with the controller, the memory being arranged to store at least one parameter giving at least one of:
1) a history of at least one variable characteristic of the light source; and/or
2) at least one fixed characteristic of the light source,
wherein the controller is arranged to drive the light source according to one of the stored history of the variable characteristic, the value of the fixed characteristic or both.

2. A lighting system according to claim 1, wherein the variable characteristic is any one or more of: light source temperature, ambient temperature, light source drive current, light source string drive current, light source activation duration, light source brightness and light source degradation.

3-7. (canceled)

8. A lighting system according to claim 1, further comprising a first temperature sensor arranged to measure the light source or the ambient temperature at a first position on the light source.

9. A lighting system according to claim 8, further comprising a second temperature sensor arranged to measure the light source temperature at a second position on the light source.

10-37. (canceled)

38. A lighting system according to claim 8, wherein the controller is arranged to carry out at least one of the following:
1) to calculate an aging parameter from the history of the light source temperature at the first position, the second position or both positions;
2) to turn off a power supply to the light source if the temperature of any part of the light source reaches a predefined threshold;
3) to use temperature measurement to increase or maximise the amount of overdrive to the light source;
4) to compensate for changes to the light source characteristics caused by changes in temperature.

39. A lighting system according to claim 1 wherein the controller is arranged to carry out at least one of the following steps:
1) calculate the age of the light source from the light source drive current;
2) to calculate the power dissipation of individual components making up the light source in accordance with light source circuit layout information;
3) to drive individual components of the light source independently;
4) to measure a current passing through each component making up the light source according to the light source circuit layout, and drive the light source such that the current in at least two of the components is equal;
5) to calculate the rise and fall edges of light source pulses according to a light source capacitance and/or inductance characteristic;
6) to use the output characteristics of the light source to linearise the output of the light source

40. A lighting system according to claim 38, wherein the memory is arranged to store a history of the age of the light source as an aging parameter within the memory.

41. A lighting system according to claim 1 wherein the fixed characteristic is any one or more of: a light source temperature/brightness graph curve, a light source drive current/brightness graph curve, light source current/voltage graph curve, a light source temperature threshold value, a light source drive current threshold value, a light source serial number uniquely identifying the light source, a light source inductance value, a light source capacitance value and light source circuit layout information.

42. A lighting system according to claim 1, further comprising a power connection between the controller and the light source arranged to provide a drive current to the light source wherein the power connection is arranged to carry data input/output to the memory and/or power to the memory.

43. A lighting system according to claim 1, wherein the memory is integral to the light source.

44. A lighting system according to claim 1, further comprising a proximity sensor arranged to detect the presence of an object near to the light source and wherein the controller is arranged to drive the light source in response to the proximity sensor.

45. A lighting system according to claim 1 wherein the controller is arranged to calculate the age of the light source form the light source drive current and wherein the calculated ageing of the light is used to
1) compensate for the ageing.
2) to predict when the light will need replacing.

46. A light source arranged to be used within the lighting system of claim 1, in particular a machine vision system.

47. A lighting controller arranged to be used within the lighting system of claim 1, in particular in a machine vision system.

48. A method of controlling a light source comprising storing a fixed characteristic of the light source and/or a history of at least one variable characteristic of the light source as a parameter and accessing that parameter when determining the voltage and/or current used to drive the light source.

49. A method according to claim 48 in which the parameter is used to determine a level of overdrive of the light source to be used to drive the light source above its nominal maximum drive current and/or maximum drive voltage.

50. A method according to claim 48 which measures the operating temperature of the light source and determines the level of overdrive from the measured temperature.

51. A method according to claim 48 which stores the history of the drive current of the light source as the parameter and uses this together with the temperature of the light source to determine the age of the light source.
